(19) United States
(12) Patent Application Publication
(10) Pub. No.: US 2007/0114242 A1
(43) Pub. Date: May 24, 2007

(54) Ergonomically-designed multi-chamber and multi-nozzle squeeze bottle

(76) Inventor: John Dodrill, Atlanta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/285,941

(22) Filed: Nov. 23, 2005

(51) Int. Cl. B67D 5/56

(52) U.S. Cl. 222/129

(57) ABSTRACT

An ergonomically-designed multi-chamber and multi-nozzle squeeze bottle comprising a plurality of separable and cooperatively-engageable chambers, wherein each chamber comprises a main reservoir portion in fluid communication with a tapered and elongated spout portion or feed neck that extends angularly and downwardly therefrom. The terminal end of each feed neck comprises a dedicated nozzle or lid associated therewith, whereupon cooperative-engagement of each chamber portion provides the multi-chamber and multi-nozzle squeeze bottle of the present invention. The present bottle is structurally configured to displace the weight of the sauce/condiment-filled bottle over the user's hand so as to alleviate hand strain and fatigue during use, and to enable equal distribution of hand and finger pressure over the bottle, such that all separate chambers thereof equally receive the requisite compressive force for delivery of smooth, even and controlled lines of dispensed sauces, condiments, liquids, and/or the like.

### TECHNICAL FIELD

The present invention relates generally to liquid-dispensing squeeze bottles, and more specifically to an ergonomically-designed multi-chamber and multi-nozzle squeeze bottle structurally designed to alleviate hand strain and fatigue during use, and to provide smooth, even and controlled lines of dispensed liquids, sauces, condiments, and the like.

### BACKGROUND OF THE INVENTION

The culinary industry is replete with a variety of food preparatory tools that facilitate the artful creation of visually-aesthetic food dishes. Indeed, the culinary arts have prompted many technological advances that seek to expedite and consistently reproduce favored food designs, arrangements, motifs and other ornamentations. Consequently, popular restaurants that commonly experience high patron occupancy rates are able to consistently reproduce and provide their patrons with high-quality, visually-fanciful signature dishes that enhance the patrons' dining experience with each repeated visit.

Although the types of food preparatory tools are many and varied, most restaurants, and more specifically the kitchens thereof, frequently utilize simple squeeze bottles to create intricate designs with flavored sauces that compliment the featured food item on the plate. For instance, squeeze bottles separately comprising chocolate, raspberry or caramel sauces may be utilized to create intricate swirls, stripes, concentric dots and/or ribbons of sauce over a desert item, and/or around the underlying plate.

However, when utilizing conventional single tip/nozzle squeeze bottles in the creation of multiple, visually-symmetrical swirls, stripes or ribbons, difficulties arise in consistent re-creation of favored designs. Additionally, such consistent re-creation requires undue expenditure of time. That is, the exact hand movement employed in the creation of a first swirl design with a first bottle is time-consuming and nearly impossible to replicate with multiple sauces from separate bottles; thus, leading to asymmetrical or uncomplimentary designs, and detraction from overall aesthetic appeal of the food dish.

Although known conventional multi-tipped and multi-chambered squeeze bottles may be utilized to simultaneously dispense a variety of sauces in equally-spaced lines, such conventional multi-tipped and multi-chambered bottles are not without marked disadvantage, as the relatively large girth of such bottles presents significant operational problems and inconsistencies.

Specifically, most conventional multi-chambered bottles are of such large girth that the average human hand is unable to effectively and fully grasp the entire bottle (i.e., unable to substantially wrap the fingers and thumb around the entire girth of the bottle) Accordingly, when hand pressure is applied during use of such bottles, an uneven distribution of pressure in exerted over the bottle, such that one or more of the chambers receives significantly more or significant less pressure than is required for a smooth, even and controlled line of dispensed sauce. Consequently, use of such bottles often results in the lines of sauces being grossly uneven or undulating in appearance, and/or lines of sauce having interruptions through the length or spread thereof. Such resulting conditions are further exacerbated, or more likely to occur, when such bottles are utilized by individuals of relatively weak hand strength and/or below-average hand size. Moreover, repeated use of such large-girth bottles often leads to hand and wrist fatigue; thereby, further contributing to the foregoing disadvantageous results. Accordingly, professional chefs and related culinary artists largely avoid use of such conventional bulky, multi-chambered/nozzle bottles.

Therefore, it is readily apparent that there is a need for an ergonomically-designed multi-chamber and multi-nozzle squeeze bottle structurally configured to displace the weight of the sauce/condiment-filled bottle over the user's hand so as to alleviate hand strain and fatigue during use. There is still a further need for an ergonomically-designed bottle structurally designed to enable the equal distribution of hand and finger pressure over the bottle, such that all separate chambers thereof equally receive the requisite compressive force for delivery of smooth, even and controlled lines of dispensed sauces, condiments, liquids, and/or the like.

### BRIEF SUMMARY OF THE INVENTION

Briefly described, in a preferred embodiment, the present invention overcomes the above-mentioned disadvantages and meets the recognized need for such an invention by providing an ergonomically-designed multi-chamber and multi-nozzle squeeze bottle comprising a plurality of separable and cooperatively-engageable chambers, wherein each chamber comprises a main reservoir portion in fluid communication with a tapered and elongated spout portion or feed neck that extends angularly and downwardly therefrom. The terminal end of each feed neck comprises a dedicated nozzle or lid associated therewith, whereupon cooperative-engagement of each chamber portion provides the multi-chamber and multi-nozzle squeeze bottle of the present invention.

According to its major aspects and broadly stated, the present invention in its preferred form is an ergonomically-designed multi-chamber and multi-nozzle squeeze bottle comprising a plurality of separable and cooperatively-engageable chamber portions, nozzled-lids associated with each such chamber portion, and a collar for securing the nozzled-lids to the cooperatively-engaged chamber portions of the present squeeze bottle.

More specifically, the present invention is an ergonomically-designed multi-chamber and multi-nozzle squeeze bottle comprising a plurality of separable and cooperatively-engageable chambers, wherein each such chamber comprises a main reservoir and a communicating feed neck. The separate chambers of the present squeeze bottle function to separately-maintain or sequester the selected sauces, condiments or other fluids contained within each such chamber during use of the present squeeze bottle. In an alternate embodiment of the present invention, the squeeze bottle may comprise internal walls extending therethrough to partition or segregate the bottle into multiple chambers for sequestration of selected sauces, condiments or other fluids within the bottle.

The feed neck of each chamber preferably comprises a substantially elongated and tapered configuration that enables a user's fingers and thumb to easily grasp and wrap therearound (i.e., enable the user's thumb to contact or overlap the user's finger tips, and/or enable the user to grasp the bottle in a manner similar to that of holding a writing utensil). Consequently, when each chamber of the bottle is cooperatively-engaged, the combined ergonomic design and structure of each feed neck effectively facilitates the equal distribution of hand and finger pressure over each feed neck, such that each feed neck equally receives the requisite compressive force for delivery of smooth, even and controlled lines of dispensed sauces, condiments, liquids, and/or the like. Furthermore, such a design significantly prevents or reduces hand and wrist strain.

Each feed neck of each chamber preferably extends angularly and downwardly from the respective reservoir portions thereof, such that when the engaged feed necks of the combined chambers are grasped by the user's hand, the engaged reservoir portions of each chamber are substantially positioned or supported upon the first dorsal interosseous muscle of the user's hand (i.e., dorsal region of hand including the arch extending between the forefinger and thumb). Such a preferred structural configuration functions to displace the weight of the sauce/condiment-filled bottle over the dorsal portion of the user's hand and, thereby, alleviate hand strain and fatigue during use of the present invention.

Preferably, the mouth or terminal end of each feed neck comprises a nozzled-lid in fluid communication therewith, and removably securable thereto via a snap-tight type interface, wherein a threaded collar is provided for additional security, if desired. In association with the alternate embodiment described hereinabove, the lid may alternatively comprise internal partitions that associate, or otherwise align, with the internal segregating or dividing walls extending through the feed neck of the bottle.

In all embodiments of the invention, however, sauces or other fluids from respective dedicated chambers of the bottle are separately-maintained during passage through each nozzle of each chamber of the present squeeze bottle. The bottle may be refilled with desired sauces, condiments or other liquids via the mouth of the feed neck, or, in another embodiment, via fill apertures disposed through the main reservoirs.

Accordingly, a feature and advantage of the present invention is its ability to provide an ergonomically-designed multi-chamber and multi-nozzle squeeze bottle that effectively reduces or eliminates hand and wrist strain during use of the bottle.

Another feature and advantage of the present invention is the ergonomic design of the feed necks, in either a separated or combined configuration, which enables equal distribution of hand and finger pressure over the feed necks for consistent delivery of smooth, even and controlled lines of dispensed sauces.

Still another feature and advantage of the present invention is its ability to displace the weight of the sauce/condiment-filled bottle over the dorsal portion of the user's hand and, thereby, alleviate hand strain and fatigue during use of the present invention.

Still yet another feature and advantage of the present invention is its ability to enable the unskilled and/or amateur culinary artists to easily and relatively effortlessly create intricate sauce designs.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a side view of a squeeze bottle according to a preferred embodiment of the present invention;

FIG. 2 is a perspective view of a squeeze bottle according to a preferred embodiment of the present invention, shown in use;

FIG. 3 is a perspective view of a squeeze bottle according to a preferred embodiment of the present invention, shown in use;

FIG. 4 is an exploded perspective view of a squeeze bottle according to a preferred embodiment of the present invention;

FIG. 5 is a perspective view of a squeeze bottle according to an alternate embodiment of the present invention;

FIG. 6 is a perspective view of a squeeze bottle according to an alternate embodiment of the present invention; and,

FIG. 7 is an exploded perspective view of a squeeze bottle according to an alternate embodiment of the present invention.

### DETAILED DESCRIPTION OF THE PREFERRED AND ALTERNATIVE EMBODIMENTS

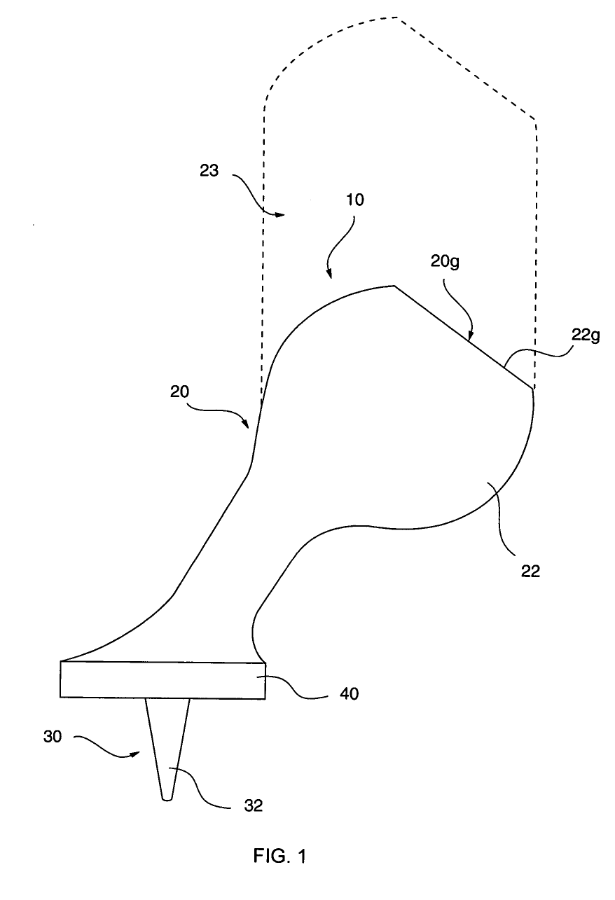

In describing the preferred and alternate embodiments of the present invention, as illustrated in FIGS. 1-7, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-4, the present invention in a preferred embodiment is an ergonomically-designed multi-chamber and multi-nozzle squeeze bottle 10, comprising chambers 20, 22, nozzled-lids 30, 32, and collar 40. To facilitate easy hand compression of bottle 10 and, thus, dispensing of sauces or liquids therefrom, chambers 20, 22 are preferably generally formed from a suitable malleable and resilient plastic, such as, for exemplary purposes only, polypropylene, high density polypropylene, low density polypropylene, polyethylene, high density polyethylene, low density polyethylene, and/or blends and mixtures thereof; however, other plastics or suitable substrates may be utilized to form chambers 20, 22. The foregoing substrates may be further utilized to form nozzled-lids 30, 32 and collar 40, but are preferably utilized in appropriate amounts and combinations to impart nozzled-lids 30, 32 and collar 40 with sufficient rigidity. Additionally, bottle 10 may be formed from any suitable bottle manufacturing process and/or part-forming machines including, without limitation, blow molding, vacuum forming, or the like.

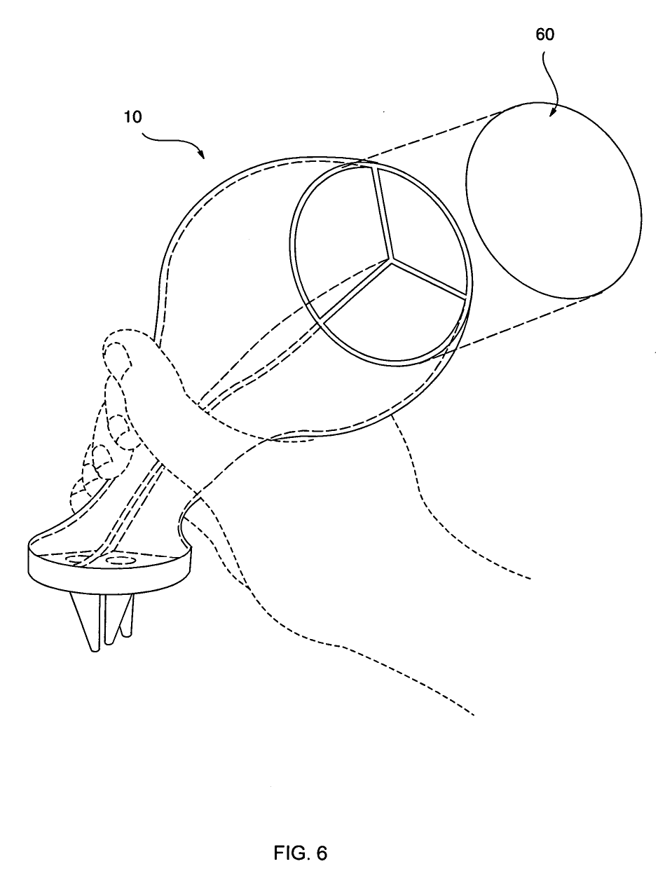

Chambers 20, 22 are preferably two separable and cooperatively-engageable, equally-volumetric, half portions of bottle 10, wherein chambers 20, 22 comprise bulbous-shaped reservoirs 20a, 22a, respectively, in fluid communication with feed necks 20b, 22b, respectively. Although FIGS. 1-4 illustrate a two-chambered bottle 10, it is contemplated that bottle 10 may comprise any number of chambers via the incorporation of additional separable and cooperatively-engageable chambers into the overall structural design and manufacture of bottle 10. An example of such an alternate embodiment is best seen with reference to FIG. 6, wherein a three-chambered squeeze bottle is illustrated; however, four-chambered squeeze bottles are further contemplated. Additionally, it should be recognized, in an alternate embodiment of the present invention, that squeeze bottle 10 may comprise integrally-formed internal walls extending therethrough to partition or segregate bottle 10 into multiple chambers for sequestration of selected sauces, condiments or other fluids therewithin. Still further, it should be recognized that chambers 20, 22 may be sized to provide any selected volume, as is illustrated in FIG. 1 with reference to phantom-lined chamber portion 23.

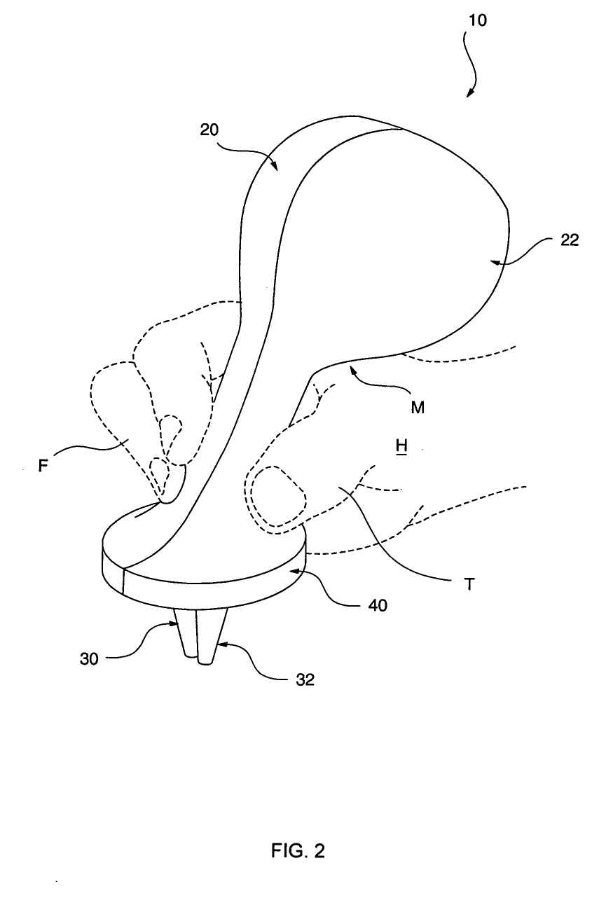

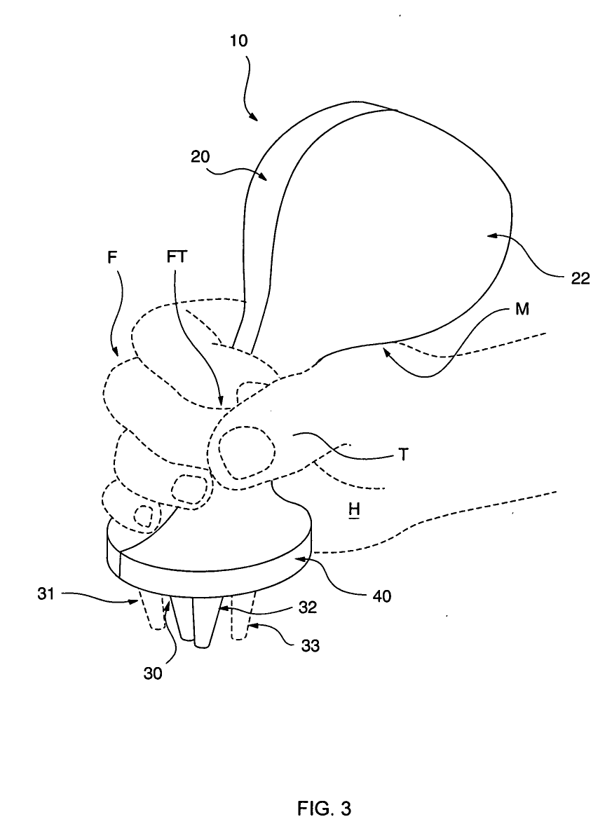

Chambers 20, 22 are preferably cooperatively-engageable via a set of interlocking ridges-and-channels 24 formed over the length of inner sides 20c, 22c of respective chambers 20, 22. Accordingly, upon cooperatively-engaging, and interlocking, chambers 20, 22, bottle 10 embodies the structural configuration best illustrated in FIGS. 2-3, wherein reservoirs 20a, 22a and feed necks 20b, 22b of respective chambers 20, 22 are brought into functional engagement to provide the benefits of a multi-chambered and multi-nozzled bottle 10 of the present invention.

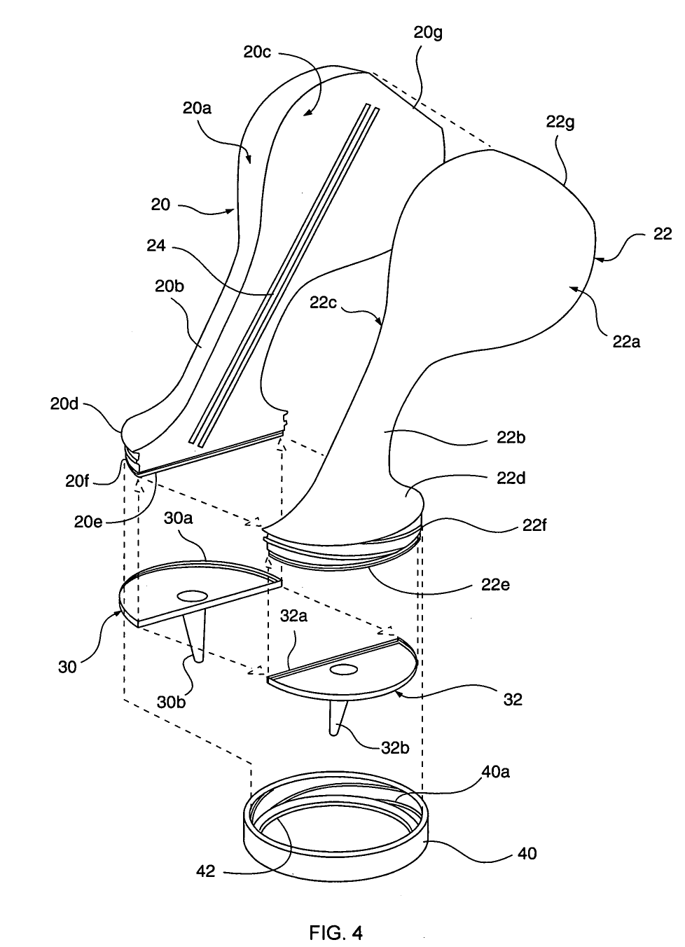

As best illustrated in FIG. 4, mouths 20d, 22d of respective feed necks 20b, 22b preferably comprise nozzled-lids 30, 32 removably securable thereto via snap-tight interfaces 20e, 22e of respective feed necks 20b, 22b and snap-tight interfaces 30a, 32a of respective nozzled-lids 30, 32. Upon snap-tight engagement of nozzled-lids 30, 32 to respective feed necks 20b, 22b, and upon cooperative engagement of chambers 20, 22 as described hereinabove, collar 40 is preferably seated over nozzled-lids 30, 32, wherein internal threads 40a of collar 40 preferably threadably-engage exterior threads 20f, 22f of respective mouths 20d, 22d of respective feed necks 20b, 22b. In such a configuration, lip 42 of collar 40 extends over, and is seated against, nozzled lids 30, 32; thereby, providing added restraint over nozzled-lids 30, 32 when secured to respective mouths 20d, 22d of respective feed necks 20b, 22b. As is further illustrated in FIG. 4, upon cooperative engagement of chambers 20, 22, mouths 20d, 22d form a circular configuration, wherein threads 20f, 22f are correspondingly brought into alignment; thus, effectively enabling circular-shaped collar 40 to be threadably-received thereby and thereover. Although snap-tight interfaces 20e, 22e, 30a, 32a are sufficiently strong to maintain nozzled-lids 30, 32 in secured communication with respective mouths 20d, 22d, even during exertion of pressure over feed necks 20b, 22b during use of bottle 10, it should be recognized that collar 40 may be selectively utilized for added security.

Preferably, when bottle 10 is fully assembled, nozzled-lids 30, 32 are in fluid communication with respective chambers 20, 22. Accordingly, sauces or other fluids from respective chambers 20, 22 are separately-maintained during passage through each nozzled-lid 30, 32. Additionally, with all embodiments of the present invention, nozzled-lids 30, 32 are preferably designed such that respective nozzle tips 30b, 32b thereof are aligned when secured to mouths 20d, 22d, and disposed in such proximity that sauces separately dispensed therefrom appear as contiguous stripes or a single, continuous ribbon over the receiving food item or plate. However, it should be recognized that the nozzles of the present invention may be arranged in any fashion and in any proximity (ex., see FIG. 3 with reference to nozzles 31, 33), and may further include alternate cross-sectional shapes to impart each dispensed sauce, or the like, with a different design or width. Additionally, it is contemplated that in a commercial embodiment of the present invention, nozzled-lids of varying structural configuration and cross-sectional shape may be provided for selective use and interchangeability for creation of alternate designs and widths of dispensed sauces.

With specific reference now to FIGS. 2-3, feed necks 20b, 22b of respective chambers 20, 22 preferably comprise a substantially elongated and tapered configuration that, in combination with the flared or sloped structural configuration of mouths 20d, 22d, enable a user's fingers F and thumb T to easily grasp and wrap therearound (i.e., enable the user to grasp the bottle in a manner similar to that of holding a writing utensil (see FIG. 2), and/or enable the user's thumb T to contact or overlap the user's finger tips FT (see FIG. 3)). Consequently, when chambers 20, 22 of bottle 10 are cooperatively-engaged, the combined ergonomic design and structure of feed necks 20b, 22b effectively facilitate the equal distribution of hand and finger pressure over each feed neck 20b, 22b, such that each feed neck 20b, 22b equally receives the requisite compressive force for delivery of smooth, even and controlled lines of dispensed sauces, condiments, liquids, and/or the like. Furthermore, such a design significantly prevents or reduces hand and wrist strain.

Additionally, and with continued reference to FIGS. 2-3, feed necks 20b, 22b of respective chambers 20, 22 preferably extend angularly and downwardly from respective reservoir portions 20a, 22a thereof, such that when feed necks 20b, 22b of assembled bottle 10 are grasped by the user's hand H, engaged reservoir portions 20a, 22a of respective chambers 20, 22 are substantially positioned or supported upon the first dorsal interosseous muscle M of the user's hand (i.e., dorsal region of hand including the arch extending between the forefinger and thumb). Such a preferred structural configuration functions to displace the weight of the sauce/condiment-filled bottle 10 over the dorsal portion of the user's hand H and, thereby, alleviate hand strain and fatigue during use of the present invention.

Furthermore, in use, a user may grasp bottle 10 as described hereinabove with a first hand, and then with a second hand, grasp reservoirs 20a, 22a to pump or squeeze additional sauces, or the like, through communicating feed necks 20b, 22b; thereby, providing a constant flow of dispensed sauces therethrough. Moreover, grasping bottle 10 in such a fashion enables a user to steadily and skillfully guide nozzle-lids 30, 32 with a first hand, and stabilize reservoirs 20a, 22a, and thus bottle 10, with the second hand. Although the present invention contemplates the simultaneous use of chambers 20, 22, it should be recognized that chambers 20, 22 may be separately or individually utilized when a single sauce, or the like, is desired.

Preferably, and as best illustrated in FIGS. 1 and 4, reservoir portions 20a, 22a of respective chambers 20, 22 comprise respective flat anterior sides 20g, 22g which facilitate the refilling process of each chamber 20, 22, in either a separated or engaged configuration. Specifically, assembled bottle 10, or each separate chamber 20, 22, is inverted and flat anterior sides 20g, 22g are seated or placed upon a flat counter surface or like, wherein anterior sides 20g, 22g, along with the overall weight and size of respective reservoirs 20a, 22a, preferably stabilize bottle 10 during the refill process. Accordingly, bottle 10, or each separate chamber 20, 22, may be selectively refilled with desired sauces, condiments or other liquids by depositing same through mouths 20d, 22d of bottle 10 following removal of respective nozzled-lids 30, 32.

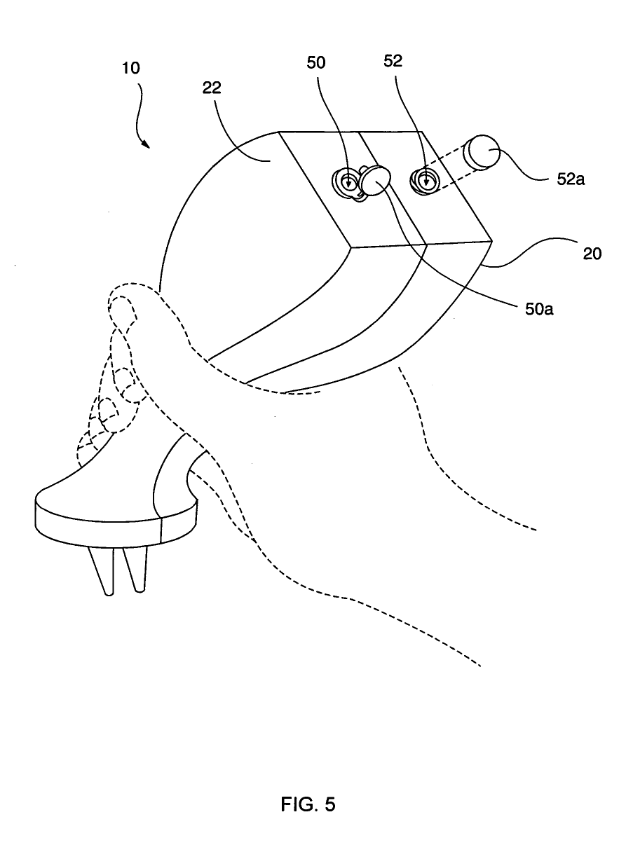

In an alternate embodiment, and as best illustrated in FIG. 5, bottle 10, or each separate chamber 20, 22, may be refilled via fill apertures 50, 52 disposed through respective reservoirs 20a, 22a, wherein fill apertures 50, 52 may comprise sealing plug 50a or threaded cap 52a to prevent spillage of the sauces, or the like, therefrom. In another alternate embodiment, and as best illustrated in FIG. 6, each reservoir of bottle 10 may be commonly covered by an anterior lid 60, whereupon removal of lid 60 provides convenient access to each such reservoir, and further provides generally larger apertures through which sauces may be deposited.

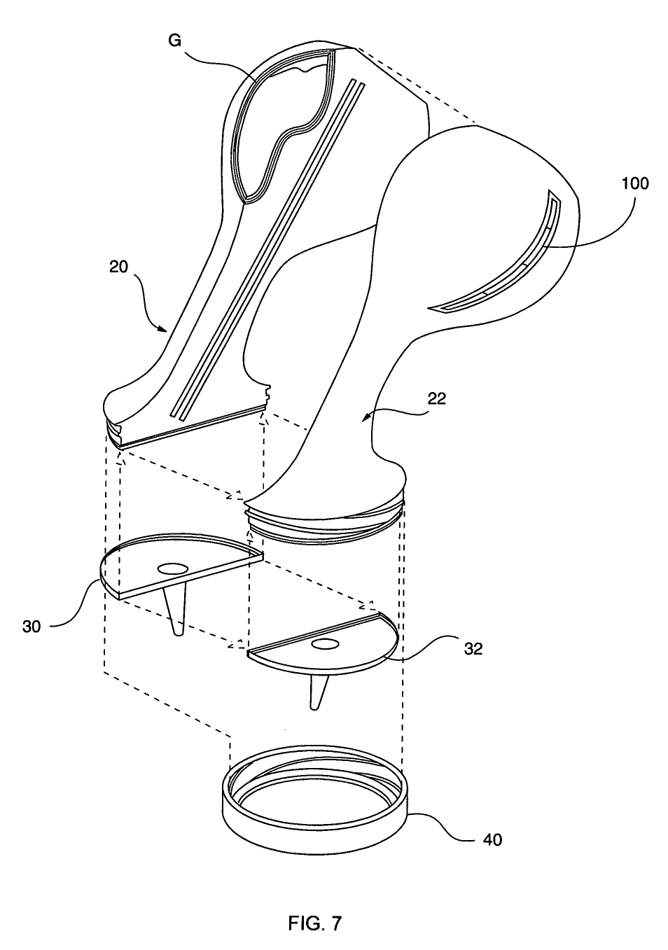

Referring now more specifically to FIG. 7, illustrated therein is an alternate embodiment of squeeze bottle 10, wherein the alternate embodiment of FIG. 7 is substantially equivalent in form and function to that of the preferred embodiment detailed and illustrated in FIGS. 1-4 except as hereinafter specifically referenced. Specifically, the embodiment of FIG. 7 incorporates an insulating gel G, or other insulating liquid, within dual-walled chambers 20, 22. Accordingly, chambers 20, 22 may be pre-heated or pre-cooled to a desired temperature prior to deposit of the desired sauces therewithin, wherein insulating gel G within the walls of each chamber 20, 22 will effectively maintain the sauces within chambers 20, 22 at a desired temperature for an operable period of time. Additionally, in conjunction with insulating gel G, or in lieu thereof, a thermometer or temperature-sensitive color-changing indicator strip 100 may be integrally-formed, or otherwise disposed over, each chamber 20, 22. As such, placement of heated sauces within chambers 20, 22 would result in indicator 100 appearing red in color (i.e., to indicate “hot” fluid), whereupon a decline in temperature of the sauces within chamber 20, 22 would result in indicator 100 changing from the color red to the color blue (i.e., to indicate “cold” fluid), or other intermittent colors to indicate a steady decline in temperature.

It should be recognized that the ergonomic construction of bottle 10 may be applied to conventional bottles devoid of any multi-chamber construction.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. An ergonomic squeeze bottle comprising:
a plurality of separable and cooperatively-engageable chambers, wherein each chamber of said plurality of separable and cooperatively-engageable chambers comprises a reservoir portion, a feed neck, and a mouth, said feed neck in fluid communication with said reservoir portion, wherein a longitudinal axis of each said mouth is angularly disposed relative to a longitudinal axis of a respective chamber of said plurality of separable and cooperatively-engageable chambers, and wherein the majority of weight of said bottle is at least partially borne by the first dorsal interosseous muscle of a user's hand when said bottle is in use.

2. The bottle of claim 1, wherein each said reservoir portion is bulbous shaped.

3. The bottle of claim 1, wherein each said feed neck comprises an elongated and tapered configuration and wherein said mouth is flared or sloped.

4. The bottle of claim 1, wherein each said feed neck comprises an elongated and tapered configuration and wherein said mouth is flared or sloped, thereby enabling the user to grasp said bottle in a manner similar to that of holding a writing utensil, and apply equal distribution of hand and finger pressure over each said feed neck when each said chamber is cooperatively-engaged to form said bottle.

5. The bottle of claim 1, wherein each said feed neck comprises an elongated and tapered configuration and wherein said mouth is flared or sloped, thereby enabling the user's thumb to contact or overlap the user's finger tips, and apply equal distribution of hand and finger pressure over each said feed neck when each said chamber is cooperatively-engaged to form said bottle.

6. The bottle of claim 1, wherein each said feed neck comprises a volumetric capacity less than that of each said reservoir portion.

7. The bottle of claim 1, wherein said longitudinal axis of each said chamber is parallel to a longitudinal axis of a respective chamber.

8. The bottle of claim 1, wherein said reservoir portions of each said chamber, when said chambers are cooperatively-engaged, result are at least partially positioned or supported upon the first dorsal interosseous muscle of the user's hand.

9. The bottle of claim 1, wherein each said mouth of each said feed neck receives a removably-securable nozzled-lid.

10. The bottle of claim 1, wherein each said mouth of each said feed neck receives an interchangeable nozzled-lid, each said nozzled-lid comprising a cross-sectional area different from another.

11. The bottle of claim 1, wherein each said mouth of each said feed neck receives a removably-securable snap-tight nozzled-lid, and wherein a lipped collar is seated over each said nozzled lid and removably secured proximate to each said mouth portion of each said feed neck.

12. The bottle of claim 1, wherein each said reservoir portion is bulbous shaped and comprises a flat surface disposed approximately opposite each said respective feed neck, wherein said flat surface enables said bottle to be seated thereon.

13. The bottle of claim 1, wherein each said reservoir portion comprises a fill aperture.

14. The bottle of claim 1, wherein each said chamber is cooperatively engageable to one another via an interlocking ridge-and-channel mechanism.

15. The bottle of claim 1, wherein at least one of said chambers comprises a contained insulating gel or liquid to maintain food contents of said chamber at a desired temperature.

16. The bottle of claim 1, wherein at least one of said chambers comprises a temperature-sensitive color-changing indicator strip or thermometer disposed thereover.

17. An ergonomic squeeze bottle comprising,
a plurality of chambers, wherein said plurality of chambers are cooperatively-engageable via at least one set of interlocking ridges and channels formed over a length of adjacent sides of respective ones of said plurality of chambers, wherein the majority of weight of said bottle is at least partially borne by the first dorsal interosseous muscle of a user's hand when said bottle is in use.

18. The bottle of claim 17, wherein said bottle comprises integrally-formed internal walls extending therethrough to partition or segregate said bottle into said plurality of chambers for sequestration of selected sauces, condiments or other fluids therewithin.

19. A method for reducing hand and wrist strain when utilizing a squeeze bottle, said method comprising the steps of:
displacing the majority of weight of the squeeze bottle at least partially over the first dorsal interosseous muscle of the hand by providing a bulbous reservoir portion a tapered neck portion depending therefrom, and a flared mouth portion depending from said tapered neck portion; and
contacting a sloped side of said bulbous reservoir portion with at least a portion of the first dorsal interosseous muscle of the hand to reduce hand and wrist strain when utilizing the squeeze bottle.

20. The method of claim 19, further comprising the step of enabling equal distribution of hand and finger pressure over a feed neck of the bottle.
